(19) United States
(12) Patent Application Publication
(10) Pub. No.: US 2025/0215252 A1
(43) Pub. Date: Jul. 3, 2025

(54) BOND BREAKER COMPOSITION

(71) Applicant: The Euclid Chemical Company, Cleveland, OH (US)

(72) Inventors: David W. Booth, Geneva, OH (US); James Keith Franey, Painesville, OH (US); Bradley Nemunaitis, Chardon, OH (US)

(73) Assignee: The Euclid Chemical Company, Cleveland, OH (US)

(21) Appl. No.: 19/009,021

(22) Filed: Jan. 3, 2025

Related U.S. Application Data
(60) Provisional application No. 63/617,213, filed on Jan. 3, 2024.

(51) Int. Cl. C09D 123/22; C04B 41/00; C04B 41/45; C04B 41/48; C04B 41/63; C09D 7/20; C09D 7/45; C09D 7/63; C09D 7/65

(52) U.S. Cl. CPC C09D 123/22; C04B 41/009; C04B 41/4535; C04B 41/4861; C04B 41/63; C09D 7/20; C09D 7/45; C09D 7/63; C09D 7/65

(57) ABSTRACT

A solvent-based bond breaker composition is disclosed comprising at least 50 wt. % of an organic solvent, a liquid release agent, and 1 to 15 wt. % of at least one film former. The liquid release agent includes 0.05 wt. % to 10 wt. % of a monosaturated fatty acid and 0 to 10 wt. % of a fatty acid ester, based on the total weight of the solvent-based bond breaker. The solvent-based bond breaker composition has a solids content of between 3% and 15%.

### CROSS-REFERENCE TO RELATED APPLICATIONS

This application claims priority to and all benefit of U.S. Provisional Patent Application No. 63/617,213, filed on Jan. 3, 2024, the entire disclosure of which is fully incorporated herein by reference.

### BACKGROUND

Concrete is one of the most commonly used construction materials for a variety of reasons, as it costs much less than other construction materials and is easy to work with. Concrete is a composite material including a mineral-based hydraulic binder (cement) which acts to adhere mineral particulates together in a solid mass. Concrete can optionally include other supplementary cementitious materials, inert fillers, property modifying chemical admixtures, coloring agents, and other additives, depending on the desired properties.

Concrete is conventionally used in the construction industry to manufacture reinforced concrete buildings, whereby a series of concrete panels are tilted up in place to form a building's exterior walls (known as “tilt-up construction”). In tilt-up construction, concrete slabs are cast horizontally on a surface of concrete slabs already pre-set on the ground. The concrete is poured into pre-shaped forms resting on the pre-set concrete slabs and allowed to set, forming a tilt wall panel. When the tilt wall panel is ready, it may be tilted into a vertical position with a crane and set on foundational footings to form the interior or exterior of a building. To ensure the tilt wall panel will release from the pre-cast slab, various release agents and bond breaker chemistries may be used. Such bond-breakers work to ensure the tilt wall panel releases with ease without cracking or damaging either panel. However, conventional release agents or bond breakers include wax or petroleum based, which change the surface of the panels on which they are applied, impacting the ability to paint or otherwise finish the panels as desired.

Thus, there remains a need in the art for improved bond breaker coatings with improved performance and processing benefits.

### SUMMARY

The general inventive concepts are directed to improved bond-breaker compositions with reduced peel strength and residual residue on the concrete panels. In various exemplary aspects, the bond-breaker composition is a solvent-based comprising a solvent-based bond breaker composition comprising at least 50 wt. % of an organic solvent, such as one or more of an aromatic hydrocarbon, isopropyl alcohol, or combinations thereof; a liquid release agent comprising: 0.05 wt. % to 10 wt. % of a monosaturated fatty acid and 0 to 10 wt. % of a fatty acid ester, based on the total weight of the solvent-based bond breaker; and 1 to 15 wt. % of at least one film former.

In other exemplary aspects, the bond-breaker composition may comprise a water-based bond breaker composition comprising 55 wt. % to 95 wt. % water; 0.5 to 20 wt. % of an organic solvent; a liquid release agent comprising 0.01 wt. % to 10 wt. % of a monosaturated fatty acid and optionally, 0 to 10 wt. % of a fatty acid ester, based on the total weight of the water-based bond breaker composition; and 1 to 15 wt. % of at least one film former. The water-based bond breaker preferably includes a high flash point solvent, having a flash point of at least 120° F.

In any of the exemplary aspects, the monosaturated fatty acid may comprise one or more of oleic acid, myristic acid, lauric acid, palmitic acid, palmitoleic acid, linoleic acid, stearic acid, or maleic acid. The fatty acid ester, if present, may comprise one or more of an ethyl ester or methyl esters of the monosaturated fatty acids provided above.

In aspects whereby the bond-breaker composition is solvent-based, the composition may further include 0.001 wt. % to 1 wt.5 of at least one rheology modifier comprising one or more of a polyamide, hydrogenated caster oil, clay or modified clay, polyamide waxes, amides, amide waxes, diamides, diamides of organic acids, reaction products of diamines and organic acids, reaction products of amides, polyurethanes, polyacrylates, polyurea dispersions, silicates, organoclays, phyllosilicates, or sulfonates.

In aspects whereby the bond-breaker composition is water-based, the composition may further comprise 0.01 to 5 wt. % of at least one wetting agent comprising one or more of a silane, fluoropolymer type wetting agent, polysiloxane, and phosphate. In any of the exemplary aspects, the wetting agent may comprise a nonionic polyether dimethylpolysiloxane dispersion.

Various aspects of the present inventive concepts are further directed to concrete slabs having first major surfaces and an opposing second major surfaces, wherein at least one of the first and second major surfaces are at least partially coated with the solvent or water-based bond-breaker composition, as disclosed herein. The bond-breaker composition is applied to at least one of the first and second major surfaces in an amount between 125 ft2/gal and 500 ft2/gal.

### DESCRIPTION OF THE FIGURES

The advantages of the inventive concepts will be apparent upon consideration of the following detailed disclosure, especially when taken in conjunction with the accompanying drawings wherein:

FIGS. 1(a) and 1(b) illustrate 4′×4′×4′ concrete slabs divided into six equal sized (2.3 ft²) testing areas coated with an exemplary water-based bond breaker composition and a comparative composition. FIG. 1(a) illustrates a pre-shaped form (with rebar directly through the center of the form) built on top of an individual testing area and filled with concrete. FIG. 1(b) illustrates the final concrete form (exemplary wall slab) after cure.

FIG. 2 illustrates a testing area of FIGS. 1(a) and (b) once the concrete wall slab is released from the floor slab.

FIG. 3 illustrates the difference in appearance (i.e., residue) between testing areas after application of the exemplary solvent-based bond breaker composition and release of a concrete wall slab (grey arrow) compared to a conventional bond-breaker composition (white arrow).

FIGS. 4(a) and 4(b) illustrate 4′×4′×4′ concrete slabs divided into six equal sized (2.3 ft²) testing areas coated with an exemplary water-based bond breaker composition and a comparative composition. FIG. 4(a) illustrates a pre-shaped form (with rebar directly through the center of the form) built on top of an individual testing area and filled with concrete. FIG. 4(b) illustrates the final concrete form (exemplary wall slab) after cure.

FIG. 5 illustrates a testing area of FIGS. 1(a) and (b) once the concrete wall slab is released from the floor slab.

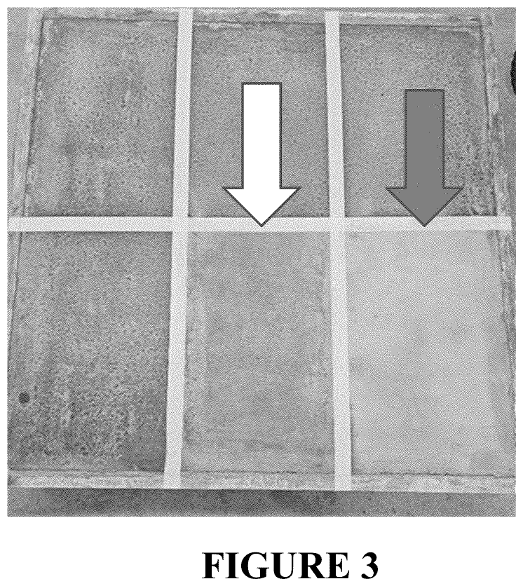

FIG. 3 illustrates the difference in appearance (i.e., residue) between testing areas after application of the exemplary water-based bond breaker composition and release of a concrete wall slab (grey arrow) compared to a conventional bond-breaker composition (white arrow).

### DETAILED DESCRIPTION

The general inventive concepts are directed to improved bond breaker compositions for use in tilt-up construction having improved release performance and reduced residue.

The term “concrete,” as used herein generally includes a material formed from a mixture of cement, coarse and/or fine aggregates (i.e., limestone, sand, and gravel), and water.

The term “tilt-up panel,” as used herein, includes any concrete slab or panel that is prepared by pouring concrete into forms positioned on the surface of a pre-cast concrete floor slab. After curing, the panel is removed from the floor surface and tilted into place to form a component of a structure's interior or exterior walls.

Tilt-up construction is a popular and recommended construction method for commercial buildings and other concrete structures. Tilt-up construction features a series of concrete tilt-up panels that have been prepared on the surface of pre-cast floor concrete slabs. The tilt-up panels are formed using shaping forms (such wood forms, plastic forms, etc.,), rebar, and concrete. The shaping forms are shaped and put in place on the surface of a horizontal pre-cast concrete slab. Concrete reinforcements, such as rebar, is placed within the forms and concrete is poured into the forms, encompassing the reinforcement materials. The material sets, forming a reinforced concrete tilt-up panel. The concrete tilt-up panel is usually positioned with the bottom of each panel adjacent to its ultimate position on the foundation. Therefore, as the panel is titled up to the vertical position and secured into place at its appropriate location and does not need to be moved into place.

Prior to placing the shaping forms on a pre-cast panel surface, the surface is covered with at least one layer of a bond-breaker composition (also known as a release agent, separation medium, etc.). The bond breaker composition may be water-based or solvent-based and work to create lower surface energy between the pre-cast horizontal concrete slab and the tilt-up wall panel to mitigate adhesion. The object of the bond breaker composition is to enable the tilt-up wall panel to be lifted from the shaping form and pre-cast horizontal concrete slab smoothly, cleanly, and without residue.

Accordingly, the subject inventive concepts are directed to solvent-based and water-based bond breaker compositions that achieve the aforementioned goals of improved release functionality and reduced surface residue.

### Solvent-Based Bond Breaker

The solvent-based bond breaker composition comprises a solvent in an amount of at least 50 wt. % of the bond breaker composition, including an amount of at least 55 wt. %, at least 60 wt. %, at least 65 wt. %, at least 70 wt. %, at least 75 wt. %, at least 80 wt. %, and at least 85 wt. %. In any of the exemplary embodiments, the solvent-based bond breaker may include between 50 wt. % and 99 wt. % of a solvent, including, for example, between 55 wt. % and 95 wt. %, between 60 wt. % and 92 wt. %, between 62 wt. % and 90 wt. %, between 65 wt. % and 88 wt. %, between 70 wt. % and 95 wt. %, between 75 wt. % and 90 wt. %, and between 78 wt. % and 89 wt. %, including all endpoints and subranges therebetween.

The solvent may comprise any conventional organic solvent, such as hydrocarbons, alcohols, esters, ethers, glycol ether, acetate, ethyl acetate, ethanol, acetone, benzene, ketones, and the like. The solvent may particularly comprise a low or no VOC (volatile organic compound) or VOC-exempt solvent. VOC-exempt solvents include, for example, acetone, dimethyl carbonate, methyl acetate, parachlorobenzotribluoride, tert-butyl acetate, and propylene carbonate. As used herein, the term “low VOC” describes a solvent whose VOC content is at or below 150 g/L. In any of the exemplary embodiments, the solvent may comprise one or more of Solvent 100, an aromatic hydrocarbon solvent, isopropyl alcohol, or combinations thereof.

The solvent-based bond breaker may further include one or more release agents, such as liquid fatty acids or salts and esters thereof. Conventional bond breaker compositions include powder-based release agents, which tend to cause processing difficulties and lack compatibility with the solvents. The liquid release agents react with the free lime in the concrete casting surface to form amorphous gels/metallic soaps that provide for clean release of cast panels.

Exemplary fatty acids useful in the bond breaker include monosaturated fatty acids, such as oleic acid, myristic acid, lauric acid, palmitic acid, palmitoleic acid, linoleic acid, stearic acid, maleic acid and the like or mixtures thereof. In particular embodiments, the fatty acid comprises liquid oleic acid.

The fatty acid may be present in the solvent-based bond breaker in an amount between about 0.05 wt. % and 10 wt. %, based on the total weight of the bonder breaker composition. In any of the exemplary embodiments, the fatty acid is present in the bonder breaker composition in an amount between 0.1 wt. % to 8 wt. %, including, for example, between 0.5 and 10 wt. %, between 0.75 wt. % and 6 wt. %, between 1 wt. % and 5 wt. %, between 1.5 wt. % and 4.5 wt. %, based on the total weight of the bond breaker composition.

Alternatively, or in addition to the fatty acid mentioned above, the solvent-based bond breaker may include one or more fatty acid esters. As the fatty acid release agents react with the concrete to form amorphous gels/metallic soaps on the concrete, the addition of a fatty acid ester (pre-reacted) creates amorphous gels/metallic soaps by itself. Thus, the fatty acid ester may be used alone as a release agent, or in addition to a fatty acid component to provide additional release functionality.

Exemplary fatty acid esters useful in the bond breaker include an ester or alkyl ester of one or more of the monosaturated fatty acids provided above. Such fatty acid esters may comprise, for example, ethyl esters, methyl esters, such as methyl oleate, and the like and combinations thereof.

The fatty acid ester may be present in the solvent-based bond breaker in an amount between about 0 and 10 wt. %, based on the weight of the bonder breaker formulation. In any of the exemplary embodiments, the fatty acid ester is present in the bonder breaker composition in an amount between 0.05 wt. % to 9 wt. %, including, for example, between 0.1 and 8 wt. %, between 0.5 and 10 wt. %, between 0.75 wt. % and 6 wt. %, between 1 wt. % and 5 wt. %, between 1.5 wt. % and 4.5 wt. %, based on the total weight of the bond breaker composition.

The solvent-based bond breaker composition may further include at least one film former. The film former may comprise polyisobutylene, polyvinylpyrrolidone, acrylates, acrylamides, copolymers, epoxy-based plasticizers, polyurethane, and the like or combinations thereof. In any of the embodiments, the film former may comprise, consist essentially of, or consist of a polyisobutylene.

In any of the exemplary embodiments, the solvent-based bond breaker comprises one or more film formers in an amount between 1 wt. % and 15 wt. %, including between 2 wt. % and 13 wt. %, between 3 wt. % and 11 wt. %, between 4 wt. % and 9 wt. %, and between 5 wt. % and 7.5 wt. %, based on the total weight of the bond breaker composition, including all endpoints and subranges there between.

The solvent-based bond breaker composition may further include at least one rheology modifier. The rheology modifier may particularly have non-settling functionality, working to prevent particles from settling in the bond breaker composition. The rheology modifier may comprise a single modifier, or may be a blend of two or more modifiers. In any of the exemplary embodiments, the rheology modifier may comprise a polyamide, hydrogenated caster oil, clay or modified clay, polyamide waxes, amides, amide waxes, diamides, diamides of organic acids, reaction products of diamines and organic acids, reaction products of amides, polyurethanes, polyacrylates, polyurea dispersions, silicates, organoclays, phyllosilicates, sulfonates or mixtures of two or more of any of these, and other known rheology modifiers.

In any of the exemplary embodiments, the solvent based bond breaker comprises one or more rheology modifiers in an amount between 0 and 2 wt. %, including, for example, between 0.001 wt. % and 1 wt. %, between 0.005 wt. % and 0.8 wt. %, between 0.005 wt. % and 0.7 wt. %, between 0.0085 wt. % and 0.5 wt. %, and between 0.01 wt. % and 0.4 wt. %, based on the total weight of the bond breaker composition, including all endpoints and subranges there between.

The solvent-based bond breaker composition may further include at least one pigment (also referred to a colorant and/or dye). The pigment may comprise any type of material and color desired for a particular end use application. In any of the exemplary embodiments, the pigment may comprise a red dye. Preferably, the pigment comprises a solvent-soluble powder material, such as, for example, Pylakrome® LX-1903.

The solvent-based bond breaker may comprise the pigment in an amount between 0.0001 wt. % and 1 wt. %, including between 0.0005 wt. % and 0.8 wt. %, between 0.001 wt. % and 0.7 wt. %, between 0.0015 wt. % and 0.5 wt. %, and between 0.002 wt. % and 0.4 wt. %, based on the total weight of the bond breaker composition, including all endpoints and subranges there between.

In any of the exemplary aspects herein, the solvent-based bond breaker may be produced by pre-mixing a solvent-based bond breaker intermediate in a first vessel, comprising solvent, alcohol, and rheology modifier(s) under high shear conditions (for example, 2,000 rpm) until uniform consistency. The solvent-bond breaker intermediate may then be added to a second vessel comprising the additional solvent, fatty acid, fatty acid ester, thickener and optional pigment and these components are then mixed under high shear (for example, 2,000 rpm) until uniform consistency. The solvent-bond breaker intermediate may be added to the second vessel in an amount between 1 wt. % and 10 wt. %, based on the total weight of the solvent-based bond breaker composition, including amounts between 2.5 and 6 wt. %, or between 3.5 and 5 wt. %.

The solvent-based bond breaker composition, prior to application to a concrete slab, has a viscosity measured with a Brookfield Viscometer using a RV1 spindle @ 20-rpm @ 75° F. of about 1 to about 25 cps, including, for example, about 2 to about 20 cps, about 3 to about 18 cps, and about 4 to about 16 cps. In any of the exemplary aspects, the solvent-based bond breaker may have a viscosity at 75° F. of about 5 to about 15 cps.

The solvent-based bond breaker composition has a solids content of less than 20%, including, for example, a solids content of between 3% and 15%, between 4% and 12%, between 5% and 10%, and between 6% and 8%, including all endpoints and subranges therebetween. In any of the exemplary embodiments, the solvent-based bond breaker composition has a solids content of between 5% and less than 7.5%, or between 5.5% and less than 7%, including all endpoints and subranges therebetween.

### Water-Based Bond Breaker

The water-based bond breaker composition comprises water in an amount of at least 50 wt. % of the bond breaker composition, including an amount of at least 55 wt. %, at least 60 wt. %, at least 65 wt. %, at least 70 wt. %, at least 75 wt. %, at least 80 wt. %, and at least 85 wt. %. In any of the exemplary embodiments, the water-based bond breaker may include between 50 wt. % and 99 wt. % of a solvent, including, for example, between 55 wt. % and 95 wt. %, between 60 wt. % and 92 wt. %, between 62 wt. % and 90 wt. %, between 65 wt. % and 88 wt. %, between 70 wt. % and 95 wt. %, between 75 wt. % and 90 wt. %, and between 78 wt. % and 89 wt. %, including all endpoints and subranges therebetween.

The water-based bond breaker may further comprise a minor portion of a solvent. The solvent may comprise any conventional organic solvent, such as hydrocarbons, alcohols, esters, ethers, glycol ether, acetate, ethyl acetate, ethanol, acetone, benzene, ketones, and the like. Preferably, the solvent comprises a high flash point solvent, having a flash point of at least 120° F., or at least 135° F., or at least 140° F. High flash point solvents improve storage stability and reduce flammability risks. The solvent may particularly comprise a low or no VOC (volatile organic compound) or VOC-exempt solvent. VOC-exempt solvents include, for example, acetone, dimethyl carbonate, methyl acetate, parachlorobenzotribluoride, tert-butyl acetate, and propylene carbonate. As used herein, the term “low VOC” describes a solvent whose VOC content is at or below 150 g/L.

In any of the exemplary embodiments, the solvent may comprise one or more of Solvent 142, an aromatic hydrocarbon solvent, isopropyl alcohol, or combinations thereof, having a flash point of greater than 142° F. The solvent may be present in the water-based bond breaker composition in an amount less than or equal to 20 wt. %, such as, for example, between 0.5 wt. % and 20 wt. %, between 1 wt. % and 18 wt. %, between 1.5 wt. % and 15 wt. %, between 2 wt. % and 13 wt. %, between 2.5 wt. % and 10 wt. %, and between 3 wt. % and 8 wt. %, including all endpoints and subranges therebetween.

The water-based bond breaker may further include one or more release agents, such as liquid fatty acids or salts and esters thereof. Conventional bond breaker compositions include powder-based release agents, which tend to cause processing difficulties and lack compatibility with the solvents. The liquid release agents react with the free lime in the concrete casting surface to form amorphous gels/metallic soaps that provide for clean release of cast panels.

Exemplary fatty acid useful in the bond breaker include monosaturated fatty acids, such as oleic acid, myristic acid, lauric acid, palmitic acid, palmitoleic acid, linoleic acid, stearic acid, maleic acid and the like. In particular embodiments, the fatty acid comprises liquid oleic acid.

The fatty acid may be present in the water-based bond breaker in an amount between about 0.01 wt. % and 10 wt. %, based on the weight of the water-based bonder breaker composition. In any of the exemplary embodiments, the fatty acid is present in the water-based bonder breaker composition in an amount between 0.05 wt. % to 8 wt. %, including, for example, between 0.1 and 6 wt. %, between 0.25 wt. % and 5 wt. %, between 0.5 wt. % and 3 wt. %, between 0.7 wt. % and 2.5 wt. %, including all endpoints and subranges therebetween, based on the total weight of the bond breaker composition.

Alternatively, or in addition to the fatty acid mentioned above, the water-based bond breaker may include one or more fatty acid esters. As mentioned above, as the fatty acid release agents react with the concrete to form amorphous gels/metallic soaps on the concrete, the addition of a fatty acid ester (pre-reacted) creates amorphous gels/metallic soaps by itself. Thus, the fatty acid ester may be used alone as a release agent, or in addition to a fatty acid component to provide additional release functionality.

Exemplary fatty acid esters useful in the bond breaker include an ester or alkyl ester of one or more of the monosaturated fatty acids provided above. Such fatty acid esters may comprise, for example, methyl esters, such as methyl oleate, and the like, and combinations thereof.

The fatty acid ester may be present in the water-based bond breaker in an amount between about 0.05 wt. % and 10 wt. %, based on the weight of the bonder breaker composition. In any of the exemplary embodiments, the fatty acid ester is present in the bonder breaker composition in an amount between 0.1 wt. % to 8 wt. %, including, for example, between 0.5 and 10 wt. %, between 0.75 wt. % and 6 wt. %, between 1 wt. % and 5 wt. %, between 1.2 wt. % and 4.5 wt. %, based on the total weight of the water-based bond breaker composition.

The water-based bond breaker composition may further include at least one film former. The film former may comprise polyisobutylene, polyvinylpyrrolidone, acrylates, acrylamides, copolymers, epoxy-based plasticizers, polyurethane, and the like or combinations thereof. In any of the embodiments, the film former may comprise, consist essentially of, or consist of a polyisobutylene.

In any of the exemplary embodiments, the water-based bond breaker comprises one or more film formers in an amount between 1 wt. % and 15 wt. %, including between 2 wt. % and 13 wt. %, between 2.5 wt. % and 10 wt. %, between 3 wt. % and 7 wt. %, and between 4 wt. % and 6.5 wt. %, based on the total weight of the water-based bond breaker composition, including all endpoints and subranges there between.

The water-based bond breaker composition may further include at least one wetting agent to improve coating properties and modify the coating's surface tension to enhance wetting capacity. Examples of suitable wetting agents that can be used include anionic, nonionic, cationic, and amphoteric wetting agents. Preferred classes of wetting agents are silanes, fluoropolymer type wetting agents, polysiloxanes, and phosphates. In any of the exemplary embodiments, the wetting agents may comprise a blend of at least one anionic wetting agent and at least one nonionic wetting agent.

In any of the exemplary embodiments, the wetting agent may include a nonionic polyether dimethylpolysiloxane dispersion. Other wetting agents for use in compositions of the present invention include the anionic phosphate ester wetting agents, as well as the substituted benzene sulfonate wetting agents.

In any of the exemplary embodiments, the water-based bond breaker comprises one or more wetting agents in an amount between 0.01 wt. % and 5 wt. %, including between 0.05 wt. % and 3 wt. %, between 0.1 wt. % and 2 wt. %, between 0.5 wt. % and 1.5 wt. %, and between 0.7 wt. % and 1.2 wt. %, based on the total weight of the bond breaker composition, including all endpoints and subranges there between.

The water-based bond breaker may further comprise antifoam agents to suppress foam forming during the formulation process and coating application, improving the dried coating quality. They can include anionic and nonionic materials, such as ethylene glycol diols, sulfate surfactants, phosphate esters, polyethylene glycol, silicone-based compositions and others.

The water-based bond breaker composition may further include at least one pigment (also referred to a colorant and/or dye). The pigment may comprise any type of material and color desired for a particular end use application. In any of the exemplary embodiments, the pigment may comprise a red dye.

The water-based bond breaker may comprise the pigment in an amount between 0.0001 wt. % and 1 wt. %, including between 0.0005 wt. % and 0.8 wt. %, between 0.001 wt. % and 0.7 wt. %, between 0.0015 wt. % and 0.5 wt. %, and between 0.002 wt. % and 0.4 wt. %, based on the total weight of the bond breaker composition, including all endpoints and subranges there between.

In any of the exemplary aspects herein, the water-based bond breaker may be produced by mixing the fatty acid, fatty acid ester, thickener and solvent in a first vessel under high shear (for example, 2,000 rpm) until uniform consistency. In a second vessel, the surfactants and antifoam agents may be mixed with water under similarly high shear conditions until uniform consistency. The two mixtures may then be combined and emulsified by adding the contents of the first vessel (oil phase) into the second vessel (water phase) and mixing under extra-high shear (for example, 6,000-8,000 rpm).

The water-based bond breaker composition, prior to application to a concrete slab, has a viscosity measured with a Brookfield Viscometer using a RV1 spindle @ 20-rpm @ 75° F. of about 1 to about 25 cps, including, for example, about 2 to about 20 cps, about 3 to about 18 cps, and about 4 to about 16 cps. In any of the exemplary aspects, the water-based bond breaker may have a viscosity at 75° C. of about 5 to about 15 cps.

The water-based bond breaker composition has a solids content of less than 20%, including, for example, a solids content of between 3% and 15%, between 4% and 12%, between 5% and 10%, and between 6% and 8%, including all endpoints and subranges therebetween. In any of the exemplary embodiments, the water-based bond breaker composition has a solids content of between 5% and less than 7.5%, or between 5.5% and less than 7%, including all endpoints and subranges therebetween. In any of the embodiments, the water-based bond breaker composition has a solids content of about 6.2 to 6.7%.

Without intention to limit the bond breaker compositions herein, exemplary compositional ranges are provided below, in Tables 1 and 2. It is to be understood that the individual compositional ranges from any of Compositions A, B, C, and D in Tables 1 and 2 may be combined with any other composition and/or combination of ingredients and are not limited to the particular combination set forth in Tables 1 and 2.

TABLE 1
Solvent-Based Bond Breaker

| | | |
|---|---|---|
| | Composition A | Composition B |
| Ingredient | (wt. % solids) | (wt. % solids) |

| | | | | |
|---|---|---|---|---|
| Solvent | 50-95 | wt. % | 70-93 | wt. % |
| Fatty Acid | 0.1-10 | wt. % | 0.5-5 | wt. % |
| Fatty Acid Ester | 0-10 | wt. % | 0.1-5 | wt. % |
| Film Former | 1-15 | wt. % | 2.5-8.5 | wt. % |
| Alcohol | 0-5 | wt. % | 0.1-1.5 | wt. % |
| Rheology Modifier | 0-3 | wt. % | 0.01-2 | wt. % |
| pigment | 0 to 2 | wt. % | 0.001-1 | wt. % |

TABLE 2
Water-Based Bond Breaker

| | | |
|---|---|---|
| | Composition C | Composition D |
| Ingredient | (wt. % solids) | (wt. % solids) |

| | | | | |
|---|---|---|---|---|
| Solvent | 0.5-20 | wt. % | 2.5-10 | wt. % |
| Fatty Acid | 0.05-8 | wt. % | 0.1-3 | wt. % |
| Fatty Acid Ester | 0-10 | wt. % | 0.1-5 | wt. % |
| Film Former | 1-15 | wt. % | 2.5-8.5 | wt. % |
| Water | 50-95 | wt. % | 75-90 | wt. % |
| Surfactant | 0.01-5 | wt. % | 0.1-2 | wt. % |
| Antifoam | 0 to 2 | wt. % | 0.05-1 | wt. % |

The bond breaker composition may be applied to a concrete slab in an amount of at least 100 ft²/gal, including, for example, between 125 ft²/gal and 500 ft²/gal, between 150 ft²/gal and 450 ft²/gal, between 175 ft²/gal and 425 ft²/gal, and between 200 ft²/gal and 400 ft²/gal (18.6 to 37.2 m²/L), including all endpoints and subranges therebetween. The composition may be applied as a single layer, or in multiple layers (i.e., two layers, three layers, etc.).

The subject bond breaker compositions can be applied to a concrete slab formed from any conventional cementitious material, such as, for example, hydraulic cement, Portland cement, modified Portland cement, Portland limestone cement, masonry cement, and mixtures thereof.

The concrete mixture further comprises an aggregate component and may include coarse aggregate, fine aggregate, or mixtures thereof. Aggregate material may comprise any conventional aggregate material, such as rock, mineral, recycled materials, synthetic materials, and the like. In any of the exemplary embodiments, the concrete mixture comprises a coarse aggregate, which may be defined as any particles having a size greater than 0.2 inch, but generally range between ⅜ and 1.5 inches in diameter, such as gravel, crushed stone (i.e., limestone). Alternatively, or in addition to, the concrete mixture comprises a fine aggregate, which generally consist of particles having a size smaller than 0.2 inches, such as sand and crushed stone.

The concrete mixture may further include supplementary cementitious materials, such as ground granulated blast furnace slag (GGBFS), fly ash, calcium carbonate, silica fume, calcined clays, metakaolin, and the like.

It has particularly been discovered that the bond breaker compositions provide a surprisingly improved (reduced) peel strength, as compared to conventional bond breaker compositions including powdered maleic and/or stearic acid additives. In particular, use of the novel bond breaker compositions reduces the load required to lift concrete wall panels and reduces the presence of residue on the panels, compared to conventional bond breaker compositions. In any of the exemplary embodiments, the novel bond breaker compositions reduces the load required to lift concrete wall panels by at least 25%, including at least 30%, at least 35%, as least 40%, at least 45%, and at least 50%, compared to conventional bond breaker compositions.

Moreover, the bond breaker compositions disclosed herein are particularly compatible with topical treatments applied to a concrete floor slab, such as densifiers, sealers, acrylic coatings, epoxy coatings, polyurethane coatings, poly urea coatings, latex coatings, and the like. If a bond breaker composition lacks compatibility with such pre-treatments, the bond breaker may react with the pre-treatment, causing residue to form on the concrete slab, which impacts the ability to further treat and finish the concrete wall.

Having generally introduced the general inventive concepts by disclosing various exemplary embodiments thereof, a further understanding can be obtained by reference to certain specific examples illustrated below which are provided for purposes of illustration only and are not intended to be all inclusive or otherwise limiting of the general inventive concepts.

### EXAMPLES

### Example 1: Water-Based Bond Breaker

An exemplary water-based bond breaker composition (Example 1) was prepared in accordance with Table 3 below. A commercial water-based bond breaker including less than 3 wt. % xylene, less than 4 wt. % butanol, and less than 0.4 wt. % ethylbenzene was prepared as a comparative example (Comp. Example A).

TABLE 3

| Ingredient | Example 1 | |
|---|---|---|
| Solvent 142 | 5-6 | wt. % |
| oleic acid | 0.1-1 | wt. % |
| methyl oleate | 1-2 | wt. % |
| polyisobutylene | 3-5.5 | wt. % |
| Anionic surfactant | 0.5-0.8 | wt. % |
| Water | 86-87 | wt. % |
| Silicone surfactant | 0.1-0.4 | wt. % |
| Antifoam | 0.1-0.4 | wt. % |

TABLE 4

| | Competitor | Example 1 |
|---|---|---|
| Product | | |
| % Solids, Method 201 | 7.75 | 6.50 |
| pH | 6.48 | 7.20 |
| Centrifuge stability, rpm at | 12,000 rpm | >15,000 rpm |
| break, 5-min test | | |
| Storage stability | | |
| 32° F. | 16-weeks 5-days | TBD |
| 75° F. | TBD | TBD |
| 120° F. | 13-weeks 5-days | 24-weeks 1-day |

As illustrated in Table 4, the composition of Example 1 demonstrated substantially increased stability (both storage and centrifuge) than that of Comp. Ex. A. The centrifuge stability test is an expedited stability test that includes putting the composition in a centrifuge for 5 minutes and increasing the centrifuge rpm until the composition breaks. The composition of Example 1 was still stable after 5 minutes at 15,000 rpm, while Comp. Ex. A failed at 12,000 rpm.

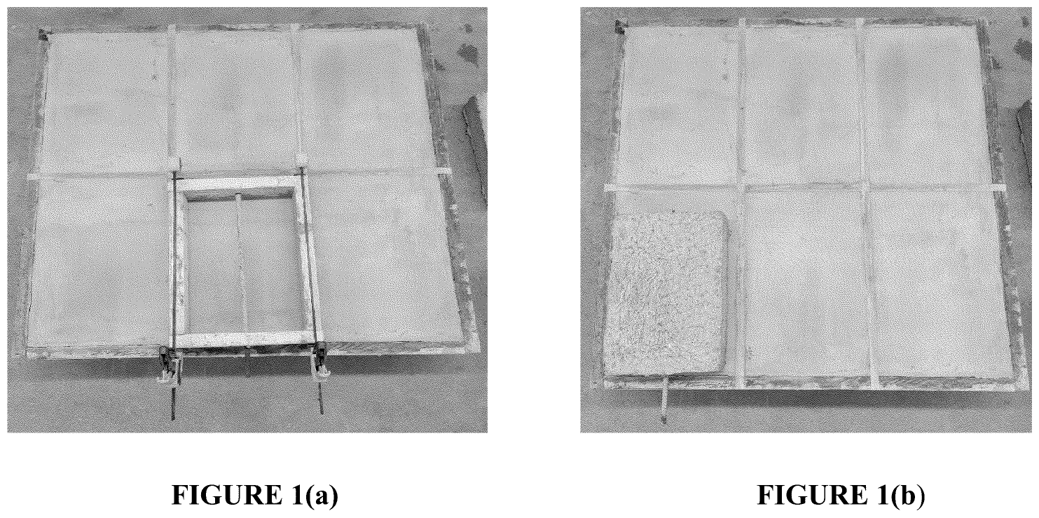

A 4′×4′×4′ concrete slab was prepared and designated the “floor slab”. When the floor slab achieved final set (4-5 hours), it was finished with a hard steel trowel. The finished floor was then divided into six equal sized (2.3 ft²) testing areas (See FIGS. 1(a) and (b)) and the bond breaker compositions were applied by spraying, low pressure/high volume with a pneumatic automotive paint sprayer at 20-psi. The compositions applied to the floor included Comp. Ex. A and five exemplary formulations (in accordance with Table 3 above) to utilize the six test areas of the floor. Three individual applications (of each material) were applied (Cure Coat—300 ft²/gal, Bond Coat #1—500 ft²/gal, Bond Coat #2—500 ft²/gal). Each coating layer applied was of the same composition. Coating layer 1 was applied immediately after the steel trowel finish, coating layer 2 was applied 3 days after coating layer 1, and coating layer 3 was applied 6 days after coating layer 1.

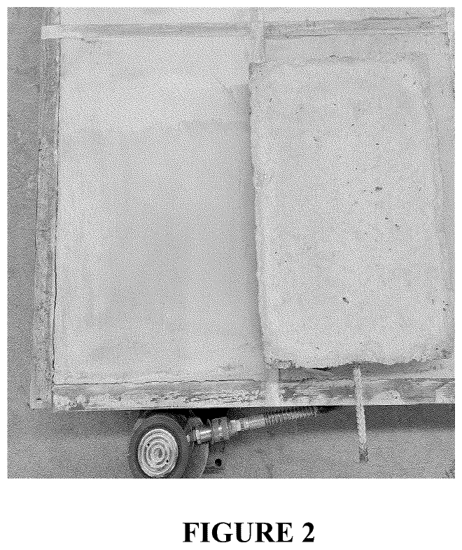

Approximately 2-3 hours after the application of coating layer 3, pre-shaped forms (with rebar directly through the center of the form and protruding through the form approx. 6-inch away, so it clears the floor) were built on top of each individual testing area and filled with concrete (see FIG. 1a). The concrete applied to the surface of the floor will be referred to as the “wall panel”. FIG. 1b illustrates the concrete wall panel after the form is removed. After 24-hours, a hydraulic jack with a load sensor was placed under the protruding rebar and the jack was actuated until the concrete wall slab released from the floor slab (FIG. 2). The load required to release the wall slab from the floor slab (in psi (pounds per square inch)) and appearance of the concrete floor and wall slabs was recorded and illustrated in Table 5, below. As indicated, the exemplary formulations required less strength to release the wall slab from the floor slab.

TABLE 5

| Products: | Comp. Ex. A | Example 1 |
|---|---|---|
| Concrete Floor Slab | 26 | 11 (about 58% |
| to Concrete Wall | | reduction) |
| Slab Adhesion, psi | | |
| Appearance | Mostly uniform on floor | Mostly uniform on floor |
| | and wall surface. | and wall surface. |
| | Appearance of the floor | |
| | and wall very dark. | |

FIG. 3 illustrates the difference in appearance between Comp. Ex. A and Example 1. As illustrated, the surface of the floor slab of Comp. Ex. A is darker (white arrow) than the surface of the floor slab of Example 1 (grey arrow), indicating that there is a buildup of residue remaining on the floor slab after release of the wall slab.

### Example 2: Solvent-Based Bond Breaker

An exemplary solvent-based bond breaker composition (Example 2) was prepared in accordance with Table 6 below. A commercial solvent-based bond breaker including less than 50 wt. % aromatic hydrocarbon, less than 50 wt. % t-butyl acetate, and less than 5 wt. % isobutyl alcohol was prepared as a comparative example (Comp. Example B).

TABLE 6

| Ingredient | Example 2 | |
|---|---|---|
| Solvent 100 | 87-93 | wt. % |
| oleic acid | 0.5-2 | wt. % |
| Methyl oleate | 0.5-2 | wt. % |
| polyisobutylene | 4-7 | wt. % |
| Isopropyl alcohol | 0.1-1 | wt. % |
| Rheology modifier | 0.01-0.05 | wt. % |
| Pigment | 0.001-0.003 | wt. % |

TABLE 7

| Product | Comp. Ex. B | Example 2 |
|---|---|---|
| % Solids, Method 201 | 8.98 | 6.81 |

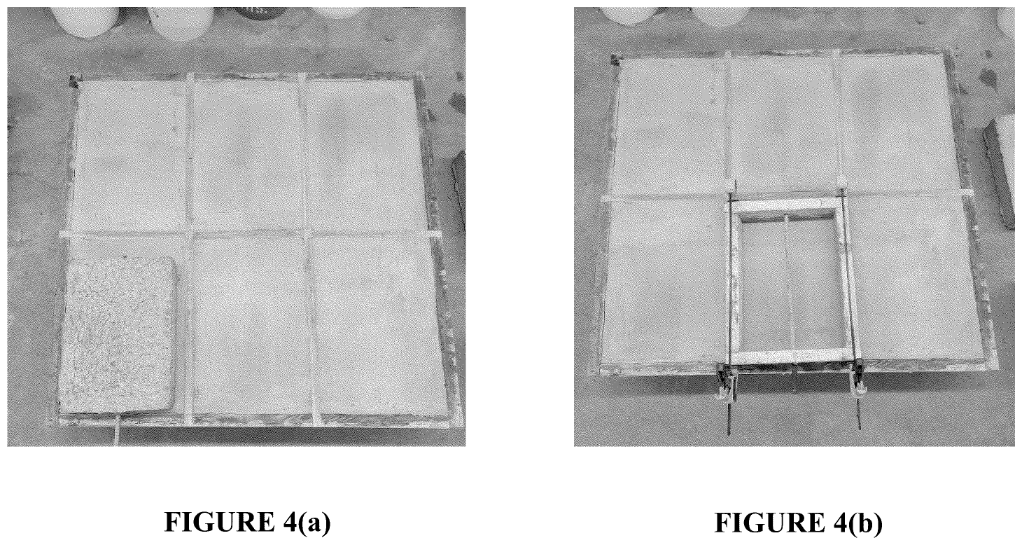

A 4′×4′×4′ concrete slab was prepared and designated the “floor slab”. When the floor slab achieved final set (4-5 hours), it was finished with a hard steel trowel. The finished floor was then divided into six equal sized (2.3 ft²) testing areas (See FIGS. 4(a) and (b)) and the bond breaker compositions were applied by spraying, low pressure/high volume with a pneumatic automotive paint sprayer at 20-psi. The compositions applied to the floor included Comp. Ex. B and five exemplary formulations (in accordance with Table 3 above) to utilize the six test areas of the floor. Three individual applications (of each material) were applied (Cure Coat—300 ft²/gal, Bond Coat #1—500 ft²/gal, Bond Coat #2—500 ft²/gal). Each coating layer applied was of the same composition. Coating layer 1 was applied immediately after the steel trowel finish, coating layer 2 was applied 3 days after coating layer 1, and coating layer 3 was applied 6 days after coating layer 1.

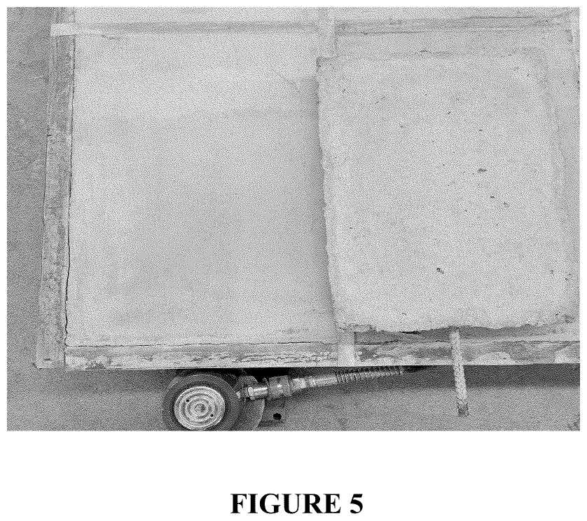

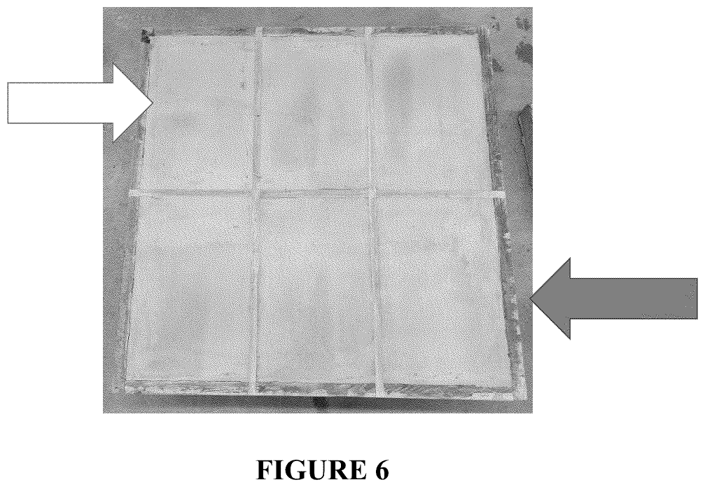

Approximately 2-3 hours after the application of coating layer 3, pre-shaped forms (with rebar directly through the center of the form and protruding through the form approx. 6-inch away, so it clears the floor) were built on top of each individual testing area and filled with concrete (see FIG. 4(a)). The concrete applied to the surface of the floor will be referred to as the “wall panel”. FIG. 4(b) illustrates the concrete wall panel after the form is removed. After 24-hours, a hydraulic jack with a load sensor was placed under the protruding rebar and the jack was actuated until the concrete wall slab released from the floor slab (FIG. 5). The load required to release the wall slab from the floor slab (in psi (pounds per square inch)) and appearance of the concrete floor and wall slabs was recorded and illustrated in Table 8, below. As indicated, the exemplary formulations required less strength to release the wall slab from the floor slab.

TABLE 8

| Products: | Comp. Ex. B | Example 2 |
|---|---|---|
| Concrete Floor Slab | 31 | 21 (about 33% |
| to Concrete Wall | | reduction) |
| Slab Adhesion, psi | | |
| Appearance | Mostly uniform on floor | Mostly uniform on floor |
| | and wall surface. | and wall surface. |
| | Appearance of the floor | Appearance of the floor |
| | and wall lightened | and wall lightened |
| | after 2-days | after 2-days. |

FIG. 6 illustrates the difference in appearance between Comp. Ex. B and Example 2. As illustrated, the surface of the floor slab of Comp. Ex. B is darker (white arrow) than the surface of the floor slab of Example 1 (grey arrow), indicating that there is a buildup of residue remaining on the floor slab after release of the wall slab.

Unless otherwise defined, all technical and scientific terms used herein have the same meaning as commonly understood by one of ordinary skill in the art to which this application pertains. Although other methods and materials similar or equivalent to those described herein may be used in the practice or testing of the exemplary embodiments, exemplary suitable methods and materials are described below. In case of conflict, the present specification including definitions will control. In addition, the materials, methods, and examples are illustrative only and not intended to be limiting of the general inventive concepts.

The terminology as set forth herein is for description of the exemplary embodiments only and should not be construed as limiting the application as a whole. Unless otherwise specified, “a,” “an,” “the,” and “at least one” are used interchangeably. Furthermore, as used in the description of the application and the appended claims, the singular forms “a,” “an,” and “the” are inclusive of their plural forms, unless contradicted by the context surrounding such.

Unless otherwise indicated, all numbers expressing quantities used in the specification and claims are to be understood as being modified in all instances by the term “about.” The term “about” means within +/−10% of a value, or in some instances, within +/−5% of a value, and in some instances within +/−1% of a value.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” Thus, use of the term “or” herein is the inclusive, and not the exclusive use.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect.

Every numerical range given throughout this specification and claims will include every narrower numerical range that falls within such broader numerical range, as if such narrower numerical ranges were all expressly written herein.

The scope of the general inventive concepts presented herein are not intended to be limited to the particular exemplary embodiments shown and described herein. From the disclosure given, those skilled in the art will not only understand the general inventive concepts and their attendant advantages but will also find apparent various changes and modifications to the devices, systems, and methods disclosed. It is sought, therefore, to cover all such changes and modifications as fall within the spirit and scope of the general inventive concepts, as described and/or claimed herein, and any equivalents thereof.

1. A solvent-based bond breaker composition comprising:
at least 50 wt. % of an organic solvent;
a liquid release agent comprising:
0.05 wt. % to 10 wt. % of a monosaturated fatty acid and 0 to 10 wt. % of a fatty acid ester, based on the total weight of the solvent-based bond breaker; and
1 to 15 wt. % of at least one film former, wherein the solvent-based bond breaker composition has a solids content of between 3% and 15%.

2. The solvent-based bond breaker composition of claim 1, wherein the solvent comprises one or more of an aromatic hydrocarbon; isopropyl alcohol, or combinations thereof.

3. The solvent-based bond breaker composition of claim 1, wherein the solvent is a low VOC solvent, a VOC-free solvent, or a VOC-exempt solvent.

4. The solvent-based bond breaker composition of claim 1, wherein the monosaturated fatty acid comprises one or more of oleic acid, myristic acid, lauric acid, palmitic acid, palmitoleic acid, linoleic acid, stearic acid, or maleic acid.

5. The solvent-based bond breaker composition of claim 1, wherein the fatty acid ester is present in the solvent-based bond breaker in an amount between 0.05 wt. % and 9 wt. %.

6. The solvent-based bond breaker composition of claim 1, wherein the fatty acid ester comprises one or more of an ethyl ester or methyl esters of a monosaturated fatty acid.

7. The solvent-based bond breaker composition of claim 1, wherein the film former comprises one or more of polyisobutylene, polyvinylpyrrolidone, acrylates, acrylamides, copolymers, epoxy-based plasticizers, or polyurethane.

8. The solvent-based bond breaker composition of claim 1, wherein the composition further includes 0.001 wt. % to 1 wt.5 of at least one rheology modifier.

9. The solvent-based bond breaker composition of claim 8, wherein the rheology modifier comprises one or more of a polyamide, hydrogenated caster oil, clay or modified clay, polyamide waxes, amides, amide waxes, diamides, diamides of organic acids, reaction products of diamines and organic acids, reaction products of amides, polyurethanes, polyacrylates, polyurea dispersions, silicates, organoclays, phyllosilicates, or sulfonates.

10. The solvent-based bond breaker composition of claim 1, wherein the composition has a viscosity measured with a Brookfield Viscometer using a RV1 spindle @ 20-rpm @ 75° F. of about 1 to about 25 cps.

11. A concrete slab having a first major surface and an opposing second major surface, wherein at least one of the first and second major surfaces are at least partially coated with the bond-breaker composition according to claim 1.

12. The concrete slab of claim 11, wherein the bond-breaker composition is applied to at least one of the first and second major surfaces in an amount between 125 ft²/gal and 500 ft²/gal.

13. A water-based bond breaker composition comprising:
55 wt. % to 95 wt. % water;
0.5 to 20 wt. % of an organic solvent;
a liquid release agent comprising:
0.01 wt. % to 10 wt. % of a monosaturated fatty acid and optionally, 0 to 10 wt. % of a fatty acid ester, based on the total weight of the water-based bond breaker composition; and
1 to 15 wt. % of at least one film former, wherein the solvent-based bond breaker composition has a centrifuge stability of at least 15,000 rpm.

14. The water-based bond breaker composition of claim 13, wherein the solvent comprises one or more of an aromatic hydrocarbon; isopropyl alcohol, or combinations thereof.

15. The water-based bond breaker composition of claim 13, wherein the solvent is a high flash point solvent, having a flash point of at least 120° F.

16. The water-based bond breaker composition of claim 13, wherein the monosaturated fatty acid comprises one or more of oleic acid, myristic acid, lauric acid, palmitic acid, palmitoleic acid, linoleic acid, stearic acid, or maleic acid.

17. The water-based bond breaker composition of claim 13, wherein the fatty acid ester is present in the solvent-based bond breaker in an amount between 0.05 wt. % and 9 wt. %.

18. The water-based bond breaker composition of claim 13, wherein the fatty acid ester comprises one or more of an ethyl ester or methyl esters of a monosaturated fatty acid.

19. The water-based bond breaker composition of claim 13, wherein the film former comprises one or more of polyisobutylene, polyvinylpyrrolidone, acrylates, acrylamides, copolymers, epoxy-based plasticizers, or polyurethane.

20. The water-based bond breaker composition of claim 13, wherein the composition further comprises 0.01 to 5 wt. % of at least one wetting agent.

21. The water-based bond breaker composition of claim 20, wherein the wetting agent comprises one or more of a silane, fluoropolymer type wetting agent, polysiloxane, and phosphate.

22. The water-based bond breaker composition of claim 13, wherein the composition has a viscosity measured with a Brookfield Viscometer using a RV1 spindle @ 20-rpm @ 75° F. of about 1 to about 25 cps.

23. A concrete slab having a first major surface and an opposing second major surface, wherein at least one of the first and second major surfaces are at least partially coated with the bond-breaker composition according to claim 13.
